(19) United States
(12) Patent Application Publication
(10) Pub. No.: US 2009/0269609 A1
(43) Pub. Date: Oct. 29, 2009

(54) Degreasing method for aluminium hard foil, aluminium hard foil, aluminium hard foil electrode member, and lithium ion secondary battery using said member

(75) Inventor: Katsuhisa Hirayama, Oyama-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: SHOWA DENKO K.K., MINATO-KU (JP)

(21) Appl. No.: 10/585,657

(22) PCT Filed: Jan. 7, 2005
(86) PCT No.: PCT/JP2005/000437

§ 371 Date: Jul. 7, 2006

Related U.S. Application Data
(60) Provisional application No. 60/565,842, filed on Apr. 28, 2004.

(30) Foreign Application Priority Data
Jan. 9, 2004 (JP) 2004-4465

(51) Int. Cl. B32B 15/01; C22F 1/04; C22C 21/00

(52) U.S. Cl. 428/606; 134/5; 420/528

(57) ABSTRACT

An aluminum hard foil is degreased without reducing the hardness to improve the coating performance of coating material. A foil-rolled aluminum foil is subjected to a low-temperature heat treatment for holding the aluminum foil at 80 to 160° C. for 1 hour or more. The low-temperature heat treatment is preferably performed by subjecting the aluminum foil to batch processing with the aluminum foil coiled.

### CROSS REFERENCE TO RELATED APPLICATIONS

This application claims priority to Japanese Patent Application No. 2004-4465 filed on Jan. 9, 2004 and U.S. Provisional Application filed on Dec. 29, 2004 (Title of Invention: Degreasing Method of Aluminum Hard Foil, Aluminum Hard Foil, Aluminum Hard Foil Electrode Material and Lithium Ion Secondary Battery Using the Same, Applicant: SHOWA DENKO K.K., Inventor: Katsuhisa HIRAYAMA, a notice of the U.S. Provisional Application No. has not reached from the U.S. Patent and Trademark Office yet), the entire disclosures of which are incorporated herein by reference in their entireties.

This application is an application filed under 35 U.S.C. §111(a) claiming the benefit pursuant to 35 U.S.C. §119(e) (1) of the filing date of U.S. Provisional Application filed on Dec. 29, 2004 (Title of Invention: Degreasing Method of Aluminum Hard Foil, Aluminum Hard Foil, Aluminum Hard Foil Electrode Material and Lithium Ion Secondary Battery Using the Same, Applicant: SHOWA DENKO K.K., Inventor: Katsuhisa HIRAYAMA, a notice of the U.S. Provisional Application No. has not reached from the U.S. Patent and Trademark Office yet) pursuant to 35 U.S.C. §111(b).

### BACKGROUND OF THE INVENTION

1. Field of the Invention

The present invention relates to a method of degreasing aluminum hard foils such as aluminum hard foils to be used as positive electrode material for lithium ion secondary batteries. It also relates to an aluminum hard foil degreased by the aforementioned method, aluminum hard foil electrode member including the aforementioned hard foil on which electrode active material is applied, and a lithium ion secondary battery using the electrode member.

In this description, the wording of “aluminum” is used in the meaning including aluminum and its alloy.

2. Description of the Related Art

The following description sets forth the inventor's knowledge of related art and problems therein and should not be construed as an admission of knowledge in the prior art.

Positive electrode member for lithium ion secondary batteries as mentioned above has been manufactured as follows. That is, active material such as LiCoO₂, electrical conducting material such as carbon and binding material such as PVD are mixed to obtain paste-like material. After applying this past-like material onto both surfaces or one surface of an aluminum hard foil about 10 to 20 μm thick to form a coating about 100 to 200 μm thick, steps of drying, pressing, slitting, and cutting are executed sequentially. As shown in FIG. 1, for example, the paste-like material is applied at certain intervals along the rolling direction (the longitudinal direction) of the aluminum hard foil 1, whereby a coated portion 2 and a non-coated portion (with no reference numeral) are formed alternatively.

In such positive electrode member, in cases where lubricating oil used at the time of rolling the aluminum hard foil remains on the surface of the foil 1, the residual lubricating oil may cause a coated portion 2 with a curved boundary portion 2a at both sides thereof as shown in FIG. 2 and/or non-uniform coating with a partially thick coated portion at an end thereof as shown in FIG. 3, which in turn causes deteriorated performance of a battery. Accordingly, as such aluminum hard foil to be used as an electrode substrate, an aluminum hard foil with less residual oil is required.

Generally, with regard to a method for degreasing aluminum foils or plates, it is known to perform washing such aluminum foils or plates with cleaning liquid, such as organic series solvent, acid liquid and alkali liquid (see Japanese Unexamined Laid-open Patent Publication Nos. H5-200406, H11-87189 and H11-229100).

Furthermore, it is also known to degrease by annealing aluminum foils.

However, in the case of the degreasing method by washing, it is troublesome to perform the method. In addition, if the cleaning liquid remains on the foil surface, the remained cleaning liquid may cause a deteriorated coating performance and adhesiveness of the aforementioned past-like material. On the other hand, in the case of the aforementioned degreasing method by annealing, the method causes the hard foil to be softened. As a result, it becomes difficult for the hard foil to maintain the hardness required as a positive electrode member for lithium ion secondary batteries.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The preferred embodiments of the present invention can significantly improve upon existing methods and/or apparatuses.

Among other potential advantages, some embodiments can provide a method for degreasing an aluminum hard foil capable of degreasing at easy steps without causing strength reduction.

In order to attain the aforementioned object, the manufacturing method of an aluminum hard foil according to the present invention has the following structure features [1] to [3].

[1] A method for degreasing an aluminum hard foil, the method comprising the step of:

subjecting a foil-rolled aluminum foil to a low-temperature treatment for holding the aluminum foil at 80 to 160° C. for 1 hour or more to degrease the aluminum foil.

[2] The method for degreasing an aluminum hard foil as recited in the aforementioned Item [1], wherein the low-temperature treatment is performed by subjecting the aluminum foil to batch processing with the aluminum foil coiled.

[3] The method for degreasing an aluminum hard foil as recited in the aforementioned Item [1] or [2], wherein the aluminum foil is 4 to 50 μm in thickness.

The aluminum hard foil according to the present invention has the following structure features [4] to [8].

[4] An aluminum hard foil obtained by subjecting a foil-rolled aluminum foil to a low-temperature treatment for holding the aluminum foil at 80 to 160° C. for 1 hour or more to degrease the aluminum foil.

[5] The aluminum hard foil as recited in the aforementioned Item [4], wherein a foil surface of the aluminum hard foil has a contact angle of less than 45°, wherein the contact angle is measured with wettability test liquid having surface tension of 0.41 N/m at 25° C. .

[6] The aluminum hard foil as recited in the aforementioned Item [4], wherein the aluminum foil is 4 to 50 μm in thickness.

[7] The aluminum hard foil as recited in the aforementioned Item [5], wherein the aluminum foil is 4 to 50 μm in thickness.

[8] The aluminum hard foil as recited in any one of the aforementioned Items [4] to [7], wherein the aluminum hard foil is a battery electrode substrate.

The aluminum hard foil electrode substrate according to the present invention has the following structure features [9] and [10].

[9] An aluminum hard foil electrode member, comprising:

an electrode substrate consisting of an aluminum hard foil obtained by subjecting a foil-rolled aluminum foil to a low-temperature heat treatment for holding the aluminum foil at 80 to 160° C. for 1 hour or more to degrease the aluminum foil; and

electrode material containing electrode active material applied on the electrode substrate.

[10] The aluminum hard foil electrode member as recited in the aforementioned Item [9], wherein the electrode material containing electrode active material is positive electrode material for lithium ion secondary batteries.

The lithium ion secondary battery according to the present invention has the following structure features [11] to [13].

[11] A lithium ion secondary battery, comprising an electrode substrate, wherein the electrode substrate consists of an aluminum hard foil obtained by subjecting a foil-rolled aluminum foil to a low-temperature heat treatment for holding the aluminum foil at 80 to 160° C. for 1 hour or more to degrease the aluminum foil.

[12] A lithium ion secondary battery, comprising an aluminum hard foil electrode material as an electrode member,

wherein the aluminum hard foil electrode member includes an electrode substrate consisting of an aluminum hard foil obtained by subjecting a foil-rolled aluminum foil to a low-temperature heat treatment for holding the aluminum foil at 80 to 160° C. for 1 hour or more to degrease the aluminum foil, and electrode material containing electrode active material applied on the electrode substrate.

[13] The lithium ion secondary battery as recited in the aforementioned Item [12], wherein the electrode material containing electrode active material is positive electrode material for lithium ion secondary batteries. Furthermore, since it is required to perform a heat treatment, the operation is simple.

According to the method for degreasing the aluminum hard foil according to the invention as recited in the aforementioned Item [1], the aluminum foil can be degreased without reducing the hardness obtained by the foil rolling to improve the coating performance and adhesion of coating material.

According to the invention as recited in the aforementioned Item [2], the low-temperature heat treatment can be performed efficiently.

According to the invention as recited in the aforementioned Item [3], an aluminum hard foil suitably used for an electrode substrate for a lithium ion secondary battery or the like can be manufactured.

The aluminum hard foil according to the invention as recited in the aforementioned Item [4] is an aluminum hard foil in which the foil surface is degreased while maintaining the hardness obtained by the foil rolling, and is excellent in coating performance and adhesion of coating material.

The aluminum hard foil according to the invention as recited in the aforementioned Item [5] is excellent especially in coating performance and adhesion.

The aluminum hard foil according to the invention as recited in the aforementioned Items [6] and [7] can be suitably used for an electrode substrate for lithium ion secondary batteries.

The aluminum hard foil according to the invention as recited in the aforementioned Item [8] can be suitably used for electrode substrate since the aluminum hard foil barely stretches even if high roll pressure is applied at the time of applying electrode active material.

The aluminum hard foil electrode member according to the invention as recited in the aforementioned Item [9] is excellent in coating performance and adhesion of electrode material containing electrode active material since the surface of the electrode member is sufficiently degreased.

The aluminum hard foil electrode member according to the invention as recited in the aforementioned Item [10] can be used as a lithium ion secondary battery positive member.

The lithium ion secondary battery according to each invention as recited in the aforementioned Items [11] to [13] can be high in capacity and high in capacity stability at the time of charging and discharging since the electrode member is excellent in coating performance and adhesion of coating material to the electrode substrate.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a schematic view showing a state in which paste is applied to an aluminum hard foil.

FIG. 2 is a schematic view showing a state in which paste is applied to an aluminum hard foil insufficiently degreased.

FIG. 3 is a cross-sectional view taken along the line III-III in FIG. 2.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

In a method according to this invention, a foil-rolled aluminum hard foil is degreased without softening the aluminum hard foil by subjecting it to a low-temperature heat treatment to improve the wettability of the foil surface and enhance the coating performance of coating materials such as electrode material. In this method, since no cleaning liquid is used, the processing can be performed easily and there is no possibility of reducing the coating performance and adhesion of coating material due to residual of cleaning liquid.

The low-temperature heat treatment is performed by holding the aluminum hard foil at 80 to 160° C. for 1 hour or more because of the following reasons. If the processing temperature is less than 80° C., degreasing effect becomes poor even if the processing is performed for a long time. To the contrary, if the temperature exceeds 160° C., the temperature softens the foil, decreasing the hardness obtained by the foil rolling. If the processing time is less than 1 hour, degreasing effect becomes poor. Accordingly, the processing time should be 1 hour or more. In this invention, since the low-temperature treatment is performed, even if the aluminum hard foil is kept for a long time period, the material strength would not deteriorate, and therefore there is no upper limit on processing time. However, even if the processing is performed for a long time period exceeding 100 hours, the degreasing effect will be saturated and therefore further degreasing effects cannot be achieved. In view of the above, the preferable processing time is 100 hours or less in terms of processing efficiency. As the processing temperature increases, degreasing can be performed more effectively, and thermal effects to a foil differ depending on the chemical composition thereof. Therefore, depending on these, the processing conditions can be set. For example, in the case of JIS (Japanese Industrial Standard) A1xxx series aluminum alloy hard foil, the processing is performed at 80 to 120° C. for 1 to 50 hours. In the case of JIS A3xxx series, the preferable processing conditions are 80 to 130° C. for 1 to 50 hours.

In the present invention, “degreasing” denotes not only to remove the oil content from a foil surface by making the oil evaporate but also to decrease the surface tension of the foil surface by making the oil content decompose or change by a heat treatment. Accordingly, the degree of degreasing is not judged by an amount of residual oil or an amount of residual decomposed or changed oil content, but judged by quality of coating performance of coating material or wettability of a foil surface. The wettability is defined by a contact angle measured with wettability test liquid having surface tension of 0.41 N/m at 25° C. The aluminum hard foil according to the present invention does not limit the intended purpose of a foil or the contact angle of a foil as defined by the wettability test liquid. However, in the case of using the aluminum hard foil as an electrode substrate for lithium ion secondary batteries, it is preferable to use an aluminum hard foil having the aforementioned contact angle of less than 45°, more preferably 40° or less, to secure the coating performance of coating material. As the aforementioned wettability test liquid, N-methyl-2-pyrrolidone can be exemplified.

The present invention does not exclude a wettability test other than the aforementioned test and an aluminum hard foil specified by such wettability test other than the aforementioned test. For example, even in cases where a contact angle measured by a test liquid having surface tension other than the above is 45° or more or wettability is defined by a method other than a contact angle, an aluminum foil having wettability equivalent to the present invention falls within the scope of the present invention.

The low-temperature heat treatment does not require rewinding of a foil required by a conventional degreasing method using cleaning liquid. Accordingly, the heat treatment can be performed by batch processing in a state in which the foil is coiled. This enables easy degreasing with a simple device. Furthermore, a plurality of aluminum hard foils can be subjected to the heat treatment simultaneously, resulting in efficient processing. However, it should be noted that the present invention does not exclude low-temperature treatment to be performed continuously while unwinding a coiled foil.

The chemical compositions of the aluminum hard foil is not specifically limited, and can be, for example, JIS A1xxx series alloy (pure aluminum series), such as JIS A1085 and A1N30, JIS A3xxx series alloy (Al—Mn series), such as JIS A3003 and A3004 and JIS A8xxx series (Al—Fe series), such as JIS A8079 and A8021 can be exemplified. These aluminum hard foils are material alloys to be used as electrode substrates for lithium ion batteries which will be discussed later.

The method according to the present invention does not limit a thickness of a targeted hard foil, but can be preferably applied to a foil having a thickness of 4 to 50 μm because of the following reasons. That is, a foil having a thickness falling within this range can be preferably used as an electrode substrate for lithium ion secondary battery electrode members and therefore the significance of applying this invention is high. More preferable foil thickness is 10 to 30 μm.

The aluminum foil to be subjected to the aforementioned low-temperature heat treatment can be manufactured by sequentially performing hot rolling, cold rolling and foil rolling in accordance with a conventional method. The low-temperature heat treatment can be performed in a state in which an aluminum foil keeps the strength obtained by work hardening at the time of foil rolling, and can be continuously performed immediately after the foil rolling or performed after a certain time has passed after the completion of foil rolling.

Thus degreased aluminum hard foil can be used as a positive electrode substrate or a negative electrode substrate of an electrode for, example, lithium ion secondary batteries. For example, electrode material can be manufactured by mixing electrode active material, electrical conducting material and binding material to form paste-like material. The past-like material is coated on one surface or both surfaces of the aluminum hard foil to have a coating of 100 to 200 μm in thickness. Then, steps of drying, press-rolling, drying for eliminating solvent, slitting and cutting are performed sequentially. Thus, an electrode member is manufactured. In the series of steps, if the substrate is a soft foil, the foil is stretched at the time of the press-rolling, causing detachment of the electrode active material, resulting in a poor battery charge collector. In order to increase battery capacity, it is necessary to increase the amount of active material, which in turn necessitates increasing the roll pressure. For this reasons, it is preferable that the foil is hard to be stretched even if high roll pressure is applied. As will be understood from the above, it is necessary to use a hard foil which is hard to be stretched as a battery electrode substrate.

The aluminum hard foil according to the present invention is improved in coating performance due to the low-temperature treatment. Therefore, uneven coating or uneven active material can be prevented at the coating step, and the foil is hard to be stretched even if high roll pressure is applied and therefore the active material is hard to be detached. This contributes to improvement of battery capacity and improvement of capacitance stability. Furthermore, since the aluminum hard foil is merely subjected to a heat treatment not using cleaning liquid or the like, there is no influence due to the residual of cleaning liquid.

### EXAMPLES

Using JIS A1085 and A3003 aluminum alloy, aluminum hard foils each having a thickness of 15 μm were manufactured by subjecting an ingot to hot rolling, cold rolling and foil rolling in accordance with a conventional method. These aluminum hard foils obtained by foil rolling correspond to H18 materials. During the cold rolling and the foil rolling, kerosine series oil whose distillation end point temperature is 300° C. or less was used as rolling oil.

Each of these aluminum foils was subjected to heat treatments of the temperature and the time shown in Table 1 (A1085) and Table 2 (A3003). Each heat treatment was performed as a batch treatment in a coiled state.

About the obtained aluminum hard foils, the degree of degreasing on the foil surface was evaluated by the below-mentioned wettability test. Further, the mechanical properties, i.e., the proof strength, the tensile strength and the elongation, were measured in accordance with a conventional method.

### [Wettability Test]

Test liquid: N-methyl-2-pyrrolidone (surface tension at 25° C.: 0.41 N/m) 0.005 cc was dropped on the foil surface with an injector, and the contact angle of the droplet was measured using a contact angle measuring instrument. The drop of the test liquid was performed by making the horizontally disposed foil approach to the nose of the injector disposed perpendicularly from beneath (raising the foil). The raising of the foil was stopped when the foil came into contact with the liquid end of the test liquid discharged from the injector without making the foil come into contact with the injector, and then the foil was moved downward after about 0.5 seconds. By holding for about 0.5 seconds after the liquid drop contact, the residual of the test liquid in the inside of the injection can be prevented, and an exact quantity of droplet can be dropped on the foil surface, and the contact angle can be measured correctly.

TABLE 1

| | | | | | Mechanical properties | | | |
|---|---|---|---|---|---|---|---|---|
| | | Heat treatment | Wettability (degreasing) | | Proof | Tensile | | |
| | | condition | Contact | Evaluation | strength | strength | Elongation | Evaluation |
| Test No. | | ° C. × time | angle (°) | *1 | (N/mm²) | (N/mm²) | (%) | *2 |
| Comp. | 1 | H18 (no heat | 47 | X | 157 | 181 | 2.8 | ⊚ |
| Example | | treatment) | | | | | | |
| | 2 | 60° C. × 12 h | 47 | X | 158 | 183 | 2.8 | ⊚ |
| | 3 | 80° C. × 0.5 h | 47 | X | 158 | 183 | 2.8 | ⊚ |
| Example | 1 | 80° C. × 24 h | 45 | ◯ | 158 | 183 | 2.8 | ⊚ |
| | 2 | 80° C. × 48 h | 43 | ⊚ | 158 | 183 | 2.8 | ⊚ |
| | 3 | 100° C. × 20 h | 45 | ◯ | 156 | 180 | 3.2 | ⊚ |
| | 4 | 100° C. × 30 h | 43 | ⊚ | 156 | 180 | 3.2 | ⊚ |
| | 5 | 120° C. × 30 h | 35 | ⊚ | 153 | 175 | 3.1 | ⊚ |
| | 6 | 120° C. × 1 h | 40 | ⊚ | 153 | 175 | 3.1 | ⊚ |
| | 7 | 130° C. × 1 h | 38 | ⊚ | 151 | 172 | 2.9 | ◯ |
| | 8 | 140° C. × 1 h | 36 | ⊚ | 149 | 169 | 2.6 | ◯ |
| | 9 | 150° C. × 1 h | 31 | ⊚ | 147 | 163 | 2.3 | ◯ |
| | 10 | 160° C. × 1 h | 32 | ⊚ | 141 | 160 | 2.4 | ◯ |
| Comp. | 4 | 180° C. × 1 h | 18 | ⊚ | 135 | 149 | 2.5 | X |
| Example | 5 | 200° C. × 1 h | 0 | ⊚ | 125 | 137 | 2.4 | X |
| | 6 | 250° C. × 1 h | 0 | ⊚ | 106 | 110 | 4.8 | X |
| | 7 | 300° C. × 1 h | 0 | ⊚ | 32 | 64 | 4.4 | X |

*1 ⊚: less than 45°, ◯: degreased, but 45° or above, X: not degreased (no change in contact angle)
*2 ⊚: improved or almost no deterioration, ◯: slightly decreased, but within an allowable range, X: deteriorated

TABLE 2

| | | | | | Mechanical properties | | | |
|---|---|---|---|---|---|---|---|---|
| | | Heat treatment | Wettability (degreasing) | | Proof | Tensile | | |
| | | condition | Contact | Evaluation | strength | strength | Elongation | Evaluation |
| Test No. | | ° C. × time | angle (°) | *1 | (N/mm²) | (N/mm²) | (%) | *2 |
| Comp. | 11 | H18 (no heat | 46 | X | 255 | 282 | 2.4 | ⊚ |
| Example | | treatment) | | | | | | |
| | 12 | 60° C. × 12 h | 46 | X | 262 | 282 | 2.4 | ⊚ |
| | 13 | 80° C. × 0.5 h | 46 | X | 263 | 285 | 2.0 | ⊚ |
| Example | 11 | 80° C. × 24 h | 45 | ◯ | 263 | 285 | 2.0 | ⊚ |
| | 12 | 80° C. × 48 h | 43 | ⊚ | 263 | 285 | 2.0 | ⊚ |
| | 13 | 100° C. × 1 h | 43 | ⊚ | 268 | 285 | 1.5 | ⊚ |
| | 14 | 100° C. × 20 h | 40 | ⊚ | 268 | 285 | 1.5 | ⊚ |
| | 15 | 100° C. × 30 h | 37 | ⊚ | 268 | 285 | 1.5 | ⊚ |
| | 16 | 120° C. × 1 h | 42 | ⊚ | 253 | 288 | 1.6 | ⊚ |
| | 17 | 120° C. × 30 h | 35 | ⊚ | 253 | 288 | 1.6 | ⊚ |
| | 18 | 130° C. × 1 h | 42 | ⊚ | 257 | 281 | 1.4 | ⊚ |
| | 19 | 140° C. × 1 h | 41 | ⊚ | 258 | 275 | 1.3 | ◯ |
| | 20 | 150° C. × 20 h | 35 | ⊚ | 258 | 275 | 1.3 | ◯ |
| | 21 | 160° C. × 1 h | 37 | ⊚ | 255 | 273 | 1.3 | ◯ |
| Comp. | 14 | 180° C. × 1 h | 20 | ⊚ | 242 | 248 | 1.8 | X |
| Example | 15 | 200° C. × 1 h | 0 | ⊚ | 228 | 222 | 1.3 | X |
| | 16 | 250° C. × 1 h | 0 | ⊚ | 170 | 160 | 1.6 | X |
| | 17 | 300° C. × 1 h | 0 | ⊚ | 140 | 111 | 4.0 | X |

*1 ⊚: less than 45°, ◯: degreased, but 45° or above, X: not degreased (no change in contact angle)
*2 ⊚: improved or almost no deterioration, ◯: slightly decreased, but within an allowable range, X: deteriorated

As shown in Tables 1 and 2, by executing a low-temperature heat treatment at certain conditions, degreasing could be achieved without causing a deterioration of mechanical properties, as compared with Comparative Examples 1 and 11. On the other hand, by the heat treatment at less than 80° C. or for less than 1 hour, no degreasing was achieved. In Comparative Examples 4 to 7, and 14 to 17 in which the heat treatment was performed at the temperature exceeding 160° C., although degreasing was achieved, the mechanical properties were deteriorated.

Furthermore, a positive electrode member (electrode member) for lithium ion secondary batteries provided with an electrode substrate made of each aluminum hard foil was manufactured.

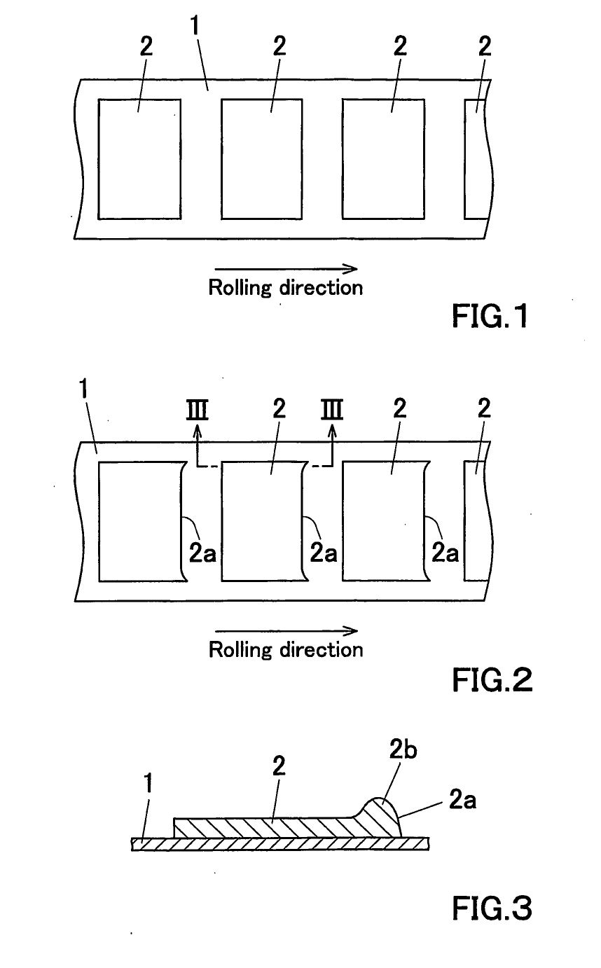

Positive electrode material (electrode material) was manufactured by mixing active material such as LiCoO₂, electrical conducting material such as carbon and binding material such as PVD to form paste-like material. The electrode material was coated on both surfaces of the aluminum hard foil to have a coating of 100 μm in thickness. As shown in FIG. 1, the coating was formed at certain intervals along the rolling direction (the longitudinal direction) of the aluminum hard foil, whereby a coated portion 2 and a non-coated portion were formed alternatively.

After the coating, drying at 200° C. for 30 minutes was performed. After the drying, the coated portions were observed. In each Example, no curvature of the boundary portion 2a or no raising of the edge portion 2b as shown in FIGS. 2 and 3 was recognized. On the other hand, in the foils of Comparative Examples 1 to 3 and 11 to 13 in which degreasing was insufficient, there were curvatures and raisings.

Furthermore, using the aluminum hard foil of Examples 1 to 21, a positive electrode member for lithium ion secondary batteries was obtained by executing each step of pressing, slitting and cutting. Using the positive electrode member, a negative electrode member made of lithium foil, and electrolytic solution in which LiPF₆ was dissolved at the concentration of 1 mol/litter in the non-aqueous series electrolytic solution containing propylene carbonate (PC) and dimethyl carbonate (DMC) mixed at the volume ratio of 1:2, a non-aqueous series secondary batteries with an exterior aluminum laminated bag (hereinafter “laminated bag battery”) were manufactured.

About the obtained laminated bag batteries, charge/discharge cycle tests were performed. As the test conditions, charge/discharge rate 1 C (coulomb) and voltage range of 3.1 to 4.3 V were set. After the charge/discharge was performed by 30 cycles, no capacity change was observed and excellent cycle performance was confirmed.

### INDUSTRIAL APPLICABILITY

The aluminum hard foil can be utilized as an electrode substrate on which paste-like electrode material is applied capable of degreasing without decreasing the strength of the aluminum hard foil and improving the coating performance of coating material.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” is meant as a non-specific, general reference and may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

1. A method for degreasing an aluminum hard foil, the method comprising the step of:
subjecting a foil-rolled aluminum foil to a low-temperature treatment for holding the aluminum foil at 80 to 160° C. for 1 hour or more to degrease the aluminum foil.

2. The method for degreasing an aluminum hard foil as recited in claim 1, wherein the low-temperature treatment is performed by subjecting the aluminum foil to batch processing with the aluminum foil coiled.

3. The method for degreasing an aluminum hard foil as recited in claim 1, wherein the aluminum foil is 4 to 50 μm in thickness.

4. An aluminum hard foil obtained by subjecting a foil-rolled aluminum foil to a low-temperature treatment for holding the aluminum foil at 80 to 160° C. for 1 hour or more to degrease the aluminum foil.

5. The aluminum hard foil as recited in claim 4, wherein a foil surface of the aluminum hard foil has a contact angle of less than 45°, wherein the contact angle is measured with wettability test liquid having surface tension of 0.41 N/m at 25° C.

6. The aluminum hard foil as recited in claim 4, wherein the aluminum foil is 4 to 50 μm in thickness.

7. The aluminum hard foil as recited in claim 5, wherein the aluminum foil is 4 to 50 μm in thickness.

8. The aluminum hard foil as recited in claim 4, wherein the aluminum hard foil is a battery electrode substrate.

9. An aluminum hard foil electrode member, comprising:
an electrode substrate consisting of an aluminum hard foil obtained by subjecting a foil-rolled aluminum foil to low-temperature heat treatment for holding the aluminum foil at 80 to 160° C. for 1 hour or more to degrease the aluminum foil; and electrode material containing electrode active material applied on the electrode substrate.

10. The aluminum hard foil electrode member as recited in claim 9, wherein the electrode material containing electrode active material is positive electrode material for lithium ion secondary batteries.

11. A lithium ion secondary battery, comprising an electrode substrate, wherein the electrode substrate consists of an aluminum hard foil obtained by subjecting a foil-rolled aluminum foil to a low-temperature heat treatment for holding the aluminum foil at 80 to 160° C. for 1 hour or more to degrease the aluminum foil.

12. A lithium ion secondary battery, comprising an aluminum hard foil electrode material as an electrode member,
wherein the aluminum hard foil electrode member includes an electrode substrate consisting of an aluminum hard foil obtained by subjecting a foil-rolled aluminum foil to a low-temperature heat treatment for holding the aluminum foil at 80 to 160° C. for 1 hour or more to degrease the aluminum foil, and electrode material containing electrode active material applied on the electrode substrate.

13. The lithium ion secondary battery as recited in claim 12, wherein the electrode material containing electrode active material is positive electrode material for lithium ion secondary batteries.
